(19) United States
(12) Patent Application Publication
(10) Pub. No.: US 2010/0013660 A1
(43) Pub. Date: Jan. 21, 2010

(54) PAIRING METHOD AND CONTROL DEVICE THEREFOR

(75) Inventors: Chang-hwan Hwang, Seoul (KR); Seung-dong Yu, Osan-si (KR); Woo-yong Chang, Yongin-si (KR); Dae-hyun Kim, Suwon-si (KR); Eun-hee Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co, Ltd., Suwon-si (KR)

(21) Appl. No.: 12/401,003

(22) Filed: Mar. 10, 2009

(30) Foreign Application Priority Data
Jul. 18, 2008 (KR) 10-2008-0070127

(51) Int. Cl. G06F 13/42

(52) U.S. Cl. 340/825

(57) ABSTRACT

A control device includes a search unit which receives profiles from each of a plurality of apparatuses in a home network and searches for a plurality of apparatuses able to be controlled in the home network, a user interface unit which displays information regarding the plurality of apparatuses found as a result of searching, and a control unit which pairs the control device with an apparatus selected from among the plurality of apparatuses found. Therefore, it is possible to provide a user with information regarding the plurality of apparatuses in the home network, so that the user may easily perform pairing using the information.

### CROSS-REFERENCE TO RELATED APPLICATIONS

This application claims priority from Korean Patent Application No. 10-2008-0070127, filed on Jul. 18, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a pairing method and a control device, and more particularly, to pairing a plurality of apparatuses in a home network with a control device, and providing the control device therefor.

2. Description of the Related Art

Remote controllers have been used to operate apparatuses in a home network. However, the recent development of video and audio media enables many apparatuses to be connected over a home network, so users need to operate each apparatus individually using a plurality of remote controllers corresponding to each apparatus, which causes user inconvenience.

However, it has become possible to use a single remote controller to operate a plurality of apparatuses rather than using a plurality of remote controllers corresponding to each respective apparatuses. A remote controller to operate a plurality of apparatuses is referred to as a composite remote controller.

Such a composite remote controller is able to perform only uni-directional communication, so users need to register information retrieval (IR) codes for each apparatus to the composite remote controller before using the composite remote controller to manipulate a plurality of apparatuses. Additionally, users also need to know the IR codes for each apparatus, and manually perform a plurality of operations to register the IR codes even when they already know the IR codes, which causes user inconvenience. Moreover, it is difficult for users to make sure that they have inputted correct IR codes.

Furthermore, since many media playback apparatuses are connected in a home network as a result of development of video and audio media, users need to repeatedly perform the above-described operations for each apparatuses which they desire to register with the composite remote controller, which also causes user inconvenience.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for pairing a plurality of apparatuses in a home network with a control device, and the control device therefor.

According to an exemplary embodiment of the present invention, there is provided a control device comprising a search unit which receives profiles from each of a plurality of apparatuses in a home network, and searches for a plurality of apparatuses able to be controlled in the home network, a user interface unit which displays information regarding the plurality of apparatuses found as a result of searching, and a control unit which pairs the control device with an apparatus selected from among the plurality of apparatuses found.

The user interface unit may comprise a plurality of keys. The user interface unit may map each of the plurality of apparatuses found to one of the plurality of keys, illuminate the plurality of keys mapped to each of the plurality of apparatuses found, and display the information regarding the plurality of apparatuses found.

The user interface unit may comprise a touch screen which displays the information regarding the plurality of apparatuses found.

The user interface unit may classify the plurality of apparatuses found according to the received profiles, and display the plurality of apparatuses classified.

The user interface unit may comprise a plurality of keys. The user interface unit may map each of the plurality of apparatuses found to one of the plurality of keys according to the type of apparatus classified, illuminate the plurality of keys mapped to each of the plurality of apparatuses found, and display the information regarding the plurality of apparatuses found.

The control unit may transmit to the paired apparatus a control code to provide feedback to the paired apparatus.

The user interface unit may comprise a plurality of keys. The user interface unit may map each of the plurality of apparatuses found to one of the plurality of keys. The feedback may comprise one among operations of displaying the name of the key mapped with the selected apparatus, displaying a message notifying pairing completion, tuning to a channel corresponding to the name of the key mapped with the selected apparatus, outputting a predetermined sound, or turning on or off.

If a confirmation command is input or if a predetermined period of time has elapsed after a control code which provides feedback to the selected apparatus is transmitted to the selected apparatus, the control unit may pair the selected apparatus with the control device.

The control unit may generate a task list containing tasks able to be performed by the paired apparatus based on the received profiles.

According to another aspect of the present invention, there is provided a pairing method of receiving profiles from each of a plurality of apparatuses in a home network, and searching for a plurality of apparatuses able to be controlled in the home network, displaying information regarding the plurality of apparatuses found as a result of searching, and pairing the control device with an apparatus selected from among the plurality of apparatuses found.

The displaying may comprise mapping each of the plurality of apparatuses found to one of a plurality of keys, illuminating the plurality of keys mapped to each of the plurality of apparatuses found, and displaying the information regarding the plurality of apparatuses found.

The displaying may further comprise displaying on a touch screen the information regarding the plurality of apparatuses found.

The displaying may further comprise classifying the plurality of apparatuses found according to the received profiles, and displaying the plurality of apparatuses classified.

The displaying may further comprise mapping each of the plurality of apparatuses found to one of the plurality of keys according to the type of apparatus classified, illuminating the plurality of keys mapped to each of the plurality of apparatuses found, and displaying the information regarding the plurality of apparatuses found.

The pairing may comprise transmitting to the paired apparatus a control code to provide feedback to the paired apparatus.

The displaying may comprise mapping each of the plurality of apparatuses found to one of the plurality of keys. The feedback may comprise one among operations of displaying the name of the key mapped with the selected apparatus, displaying a message notifying pairing completion, tuning to a channel corresponding to the name of the key mapping with the selected apparatus, outputting a predetermined sound, or turning on or off.

The pairing may comprise, if a confirmation command is input or if a predetermined period of time has elapsed after a control code to provide feedback to the selected apparatus is transmitted to the selected apparatus, pairing the selected apparatus with the control device.

The pairing method may further comprise generating a task list containing tasks able to be performed by the paired apparatus based on the received profiles.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of a control device according to an exemplary embodiment of the present invention;

FIGS. 2 to 4 exemplarily illustrate a control device implemented in the form of a remote controller having a plurality of keys according to an exemplary embodiment of the present invention;

FIG. 5 exemplarily illustrates a control device implemented in the form of a remote controller having a liquid crystal display (LCD) window according to an exemplary embodiment of the present invention; and

FIG. 6 is a flowchart explaining a pairing method according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

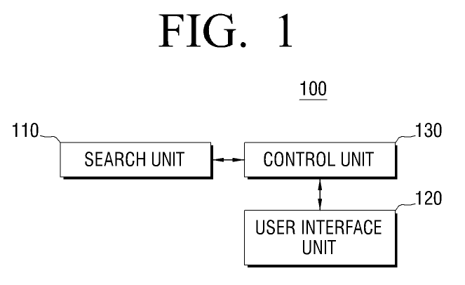

FIG. 1 is a block diagram of a control device 100 according to an exemplary embodiment of the present invention. The control device 100 of FIG. 1 comprises a search unit 110, a user interface unit 120 and a control unit 130. The control device 100 may be implemented as a digital television (DTV) or a remote controller. The control device 100 may bi-directionally communicate with a plurality of apparatuses in a home network, and control each of the plurality of apparatuses. Bi-directional communication includes not only all existing communication technologies, such as the Bluetooth (BT), radio frequencies (RF), wireless fidelity (Wi-Fi), high definition multimedia interface (HDMI)-consumer electronics control (CEC) or wireless HDMI-CEC, but also bi-directional communication technologies which may be developed in the future.

The search unit 110 receives profiles from each of the plurality of apparatuses in the home network, and also searches for apparatuses able to be controlled in the home network. Specifically, the search unit 110 broadcasts a profile request signal to search for apparatuses which are able to be controlled in the home network, and receives profiles from each of the plurality of apparatuses which responded to the profile request signal, so that the search unit 110 knows which apparatuses are able to be controlled in the home network based on the received profiles.

The plurality of apparatuses may include a TV, a set-top box (STB), a home theater system (HTS), a blue-ray disc player (BDP), a digital video disk player (DVDP), a hard disc drive recorder (HDDR), a portable multimedia player (PMP), a digital still camera (DSC), or other apparatuses capable of being connected over the home network. The BDP is a high-density optical disc player capable of recording a disc with a capacity of ten gigabytes (GB) or greater. Additionally, each of the profiles may comprise information including an identifier (ID) a manufacturer, or function of the respective apparatuses.

If a user enters a pairing command into the control device 100, the search unit 110 may search for apparatuses able to be controlled in the home network. Alternatively, the search unit 110 may periodically search for apparatuses able to be controlled in the home network. In this situation, if a new apparatus other than a pre-registered apparatuses is found as a result of searching, the search unit 110 may perform operations that will be described later.

The user interface unit 120 displays information regarding the apparatuses found as a result of searching by the search unit 110. Specifically, the user interface unit 120 classifies the apparatuses found according to the manufacturer or the type of apparatus, based on the profiles received by the search unit 110, and displays information regarding the type of apparatus, the apparatus manufacturer, or the number assigned to the respective found apparatuses. For example, the user interface unit 120 may be implemented as an apparatus, such as a touch pad, which is able to simultaneously implement input and output this information, in order to display manufacturer information or apparatus information.

The user interface unit 120 comprises a plurality of keys. The user interface unit 120 maps each of the apparatuses found to one of the plurality of keys, and illuminates the plurality of keys mapped to each of the apparatuses found in order to provide a user with the information regarding the apparatuses found. Specifically, the plurality of keys of the user interface unit 120 are able to be illuminated so that a user can set or select various functions for controlling the plurality of apparatuses in the home network. The user interface unit 120 may map each of the apparatuses found to one of the plurality of keys according to the type of apparatus, and may then illuminate the plurality of keys mapped to each of the apparatuses found, so that a user may be provided with the information regarding the apparatuses found. Such information includes numbers assigned to the apparatuses found or the type of apparatus found. For example, if the search unit 110 finds a TV, a DVD and an HTS in the home network, the user interface unit 120 may assign numbers 1, 2 and 3 to the TV, DVD and HTS, respectively, map the TV, DVD and HTS to number keys 1, 2 and 3, respectively, and illuminate the number keys 1, 2 and 3, so as to notify the user that three apparatus have been found after the search is performed.

The user interface unit 120 determines whether there are pre-registered apparatuses among the apparatuses found, and displays information regarding apparatuses other than the pre-registered apparatuses. The user interface unit 120 may display all the apparatuses found without performing the determining operation. The determining operation may be performed by the user interface unit 120 or the search unit 110.

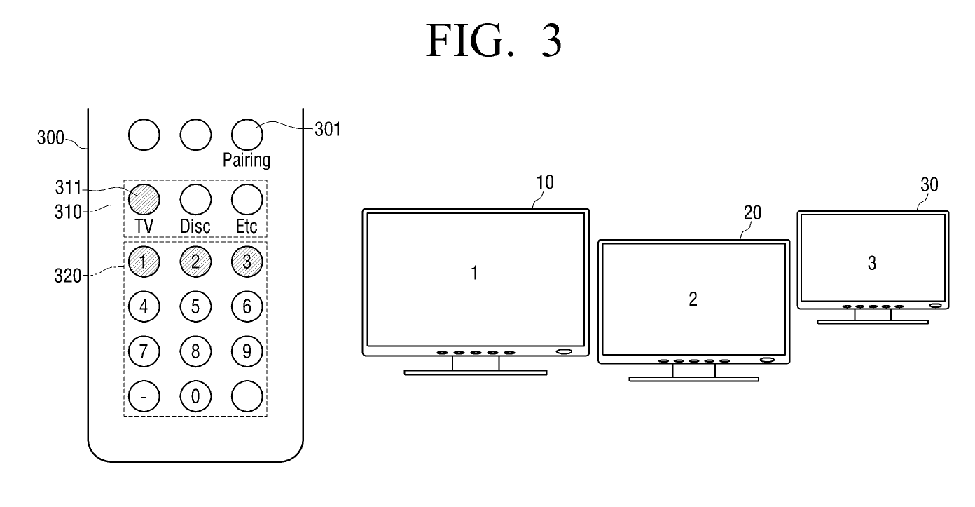

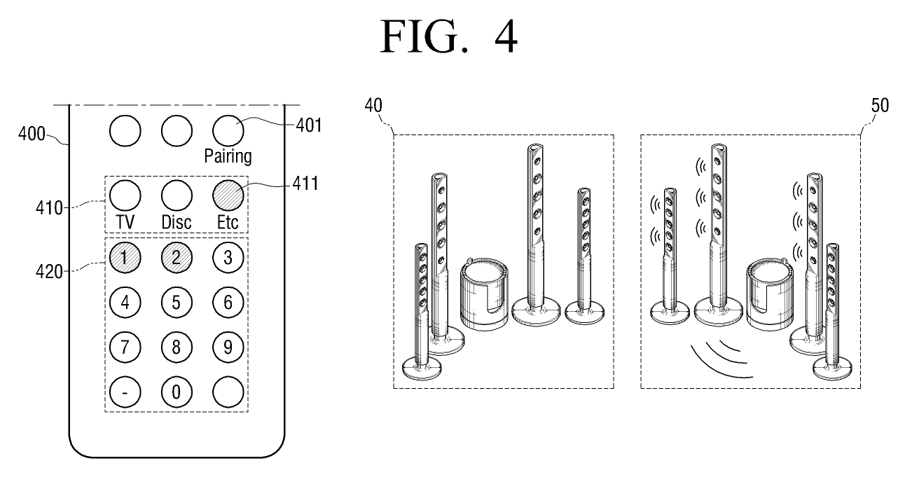

The user interface unit 120 comprises a separate key to perform only the function of receiving a user pairing command, for example, pairing keys 301 and 401 illustrated in FIGS. 3 and 4, respectively. Additionally, if a user presses a key on a conventional remote controller or DTV, the user interface unit 120 may determine that the user pairing command has been received. For example, if a user presses a certain function key and then presses a mode change key, or if the user presses a mode change key repeatedly during a short period of time, or if the user continues to press a mode change key for a long period of time, the user interface unit 120 may determine that the user pairing command has been selected. The user pairing command may be input by various methods other than those described above.

If a user selects one among the apparatuses found through the user interface unit 120, the control unit 130 may register the selected apparatus as a controllable apparatus. Specifically, in this situation, the control unit 130 may generate a task based on a profile of the selected apparatus, and may form a task list containing various control commands for the created task. Accordingly, if the user desires to operate the selected apparatus, the control unit 130 may output a control command to control the selected apparatus using the task list so that the task associated with the selected apparatus may be performed.

Here, tasks may include, for example, watching TV, watching a recorded program, playing back a disk, listening to the radio, listening to music, viewing still images, viewing moving images, or turning on or off all apparatuses. Such tasks may be previously set, or may be generated based on profiles collected from each of the plurality of apparatuses in the home network. Additionally, such tasks may be generated based on the selected apparatus, or all the registered apparatuses. For example, if a TV, a DVDP and an HTS are connected to the home network, the control unit 130 may generate a task list containing a ‘watching TV’ task which is able to be performed by the TV and HTS, a ‘watching a DVD’ task able to be performed by the TV, DVDP and HTS or other tasks.

Additionally, the control unit 130 transmits a control code to an apparatus selected by the user, so that the apparatus may perform a feedback operation in response to the user pairing command. In more detail, the control unit 130 causes the selected apparatus to perform a predetermined operation as a feedback in response to the user's selection of the apparatus. The predetermined operation may include, for example, displaying the name of the key mapped with the selected apparatus, displaying a message notifying pairing completion, tuning to a channel corresponding to the name of the key mapping with the selected apparatus, or outputting a certain sound.

After the selected apparatus performs the predetermined operation, if the user enters a confirmation command or if a predetermined period of time has elapsed, the control unit 130 may pair the selected apparatus with the control device 100. Accordingly, the control device 100 may cause the apparatus currently selected by the user to perform a feedback operation in response to the user's selection of the apparatus, which may increase user convenience.

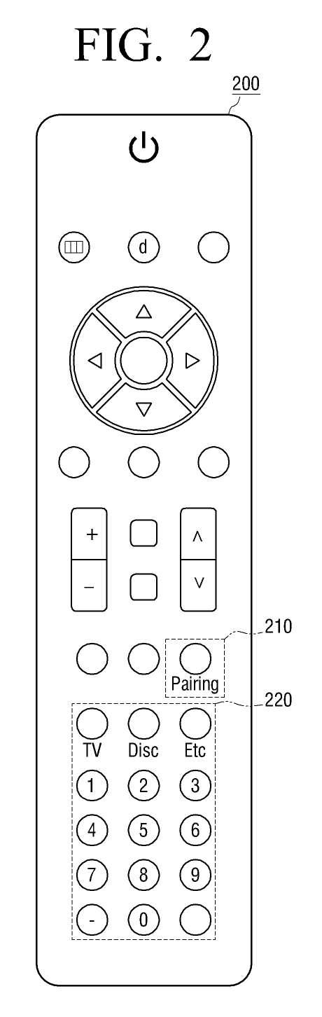

FIGS. 2 to 4 illustrate a control device implemented in the form of a remote controller having a plurality of keys according to an exemplary embodiment of the present invention.

FIG. 2 illustrates an exemplary embodiment in which the control device 100 of FIG. 1 is implemented as a remote controller 200 having a plurality of keys. The remote controller 200 of FIG. 2 comprises a pairing key 210 and a plurality of function keys 220. The pairing key 210 is disposed separately from the plurality of function keys 220, and is used to receive a user pairing command and perform only the user pairing command. The plurality of function keys 220 are used to receive a user's selection of an apparatus during a pairing process and to display information on the selected apparatus, for example, information on the number of apparatuses selected or the type of apparatus selected.

FIG. 3 illustrates an exemplary embodiment in which the control device 100 of FIG. 1 is implemented as a remote controller 300 having a plurality of keys. In FIG. 3, three TVs 10, 20 and 30 are able to perform bi-directional communication in a home network. Since the three TVs 10, 20 and 30 are able to be paired with the remote controller 300, the remote controller 300 illuminates a TV change key 311, and number keys 1, 2 and 3 which are disposed on a number key field 320 and map with the three TVs 10, 20 and 30, respectively. Accordingly, it is possible to inform a user that three apparatuses have been found by the remote controller 300. Additionally, if the user selects one among the number keys 1, 2 and 3, the remote controller 300 may be paired with the TV corresponding to the selected number key.

In response to the user's selection of the number key, the remote controller 300 may transmit a control code to the paired TV, so that the paired TV may perform a feedback operation, such as displaying the name of the number key mapping with the paired TV, displaying a message notifying pairing completion, tuning to a channel corresponding to the number key mapping with the paired TV, or outputting a certain sound. Accordingly, it is possible for the user to check whether he or she selected an apparatus which he or she desires to pair with the control device.

Additionally, the remote controller 300 may transmit a control code to control the name of keys mapped with all apparatuses to be displayed, or to control channels corresponding to the name of keys mapped with selected apparatuses to be displayed, so that the user may know which apparatuses were found as a result of searching using displayed information and may select a desired apparatus from those found.

FIG. 4 illustrates an exemplary embodiment in which the control device 100 of FIG. 1 is implemented as a remote controller 400 having a plurality of keys. In FIG. 4, a home network comprises two HTSs 40 and 50 able to perform bi-directional communication. Since the two HTSs 40 and 50 are able to be paired with the remote controller 400, the remote controller 400 illuminates an et cetera (ETC) change key 411, and number keys 1 and 2 which are disposed on a number key field 420, map to the HTSs 40 and 50, respectively.

Accordingly, a user may be notified that two apparatuses have been found. Additionally, if the user selects one of the number keys 1 and 2, the remote controller 400 may be paired with the HTS corresponding to the selected number key. In response to the user's selection of the number key, the remote controller 400 may transmit a control code to allow the paired HTS, which is assigned to the selected number key, to output a certain sound, so the user is notified of which HTS has been selected. For example, the paired HTS may output a beep sound or a pre-stored sound notifying the user of the selected number.

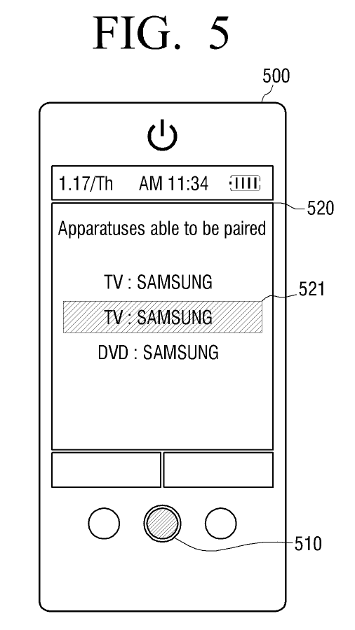

FIG. 5 illustrates a remote controller 500 having a liquid crystal display (LCD) window according to an exemplary embodiment of the present invention.

The remote controller 500 illustrated in FIG. 5 may display information regarding apparatuses, which are able to be paired with the remote controller 500 on a user interface (UI) window 520, in response to the user pairing command. In this exemplary embodiment, information regarding the type of apparatus and apparatus manufacturer may also be displayed on the UI window 520 using received profiles. The UI window 520 comprises a first display field to display information regarding apparatuses found as a result of searching, and a second display field to display information regarding the selected apparatus. Additionally, various display patterns may be used to display tasks of the apparatuses, which are able to be paired with the remote controller 500 on the UI window 520.

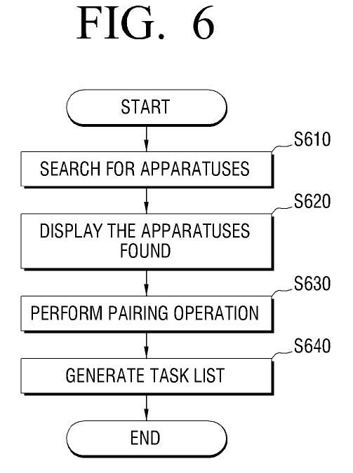

FIG. 6 illustrates a flowchart explaining a pairing method according to an exemplary embodiment of the present invention.

If a user pairing command is received by the control device 100, a search for apparatuses able to be controlled in a home network is performed (S610). In more detail, a profile request signal is broadcasted to search for apparatuses able to be controlled in the home network, and profiles are received from each of a plurality of apparatuses in the home network which respond to the profile request signal, so it is possible for a user to know which apparatuses are able to be controlled in the home network based on the received profiles. The searching operation may be periodically performed. Additionally, if a new apparatus is found as a result of searching, the operations described above may be performed.

If the searching operation is finished, information regarding apparatuses found as a result of searching is displayed so that a user may be provided with the information (S620). Specifically, the apparatuses found are classified according to the manufacturer or the type of apparatus, based on the received profiles, and information regarding the type of apparatus, the apparatus manufacturer or the numbers assigned to the respective found apparatuses is displayed. For example, if an exemplary embodiment of the present invention is applied to a remote controller having a plurality of keys, the remote controller may map each of the apparatuses found to one of the plurality of keys, and may then illuminate the plurality of keys mapping with the apparatuses found, so that the information regarding the apparatuses found may be provided to the user. Alternatively, if the present invention is applied to a remote controller having a touch screen, the information regarding the apparatuses found may be displayed on the touch screen.

If the user selects one among the apparatuses found, a pairing operation is performed with the selected apparatus (S630). Specifically, the selected apparatus performs a predetermined operation as feedback in response to the user's selection of the apparatus. Next, if the user enters a confirmation command or if a predetermined period of time has elapsed, the pairing operation may be performed with respect to the selected apparatus.

A task list containing tasks able to be performed by the paired apparatus is generated based on the received profiles (S640). In more detail, if the user selects one of the apparatuses found, a task list may be formed which contains at least one task which is able to be performed by the selected apparatus, a control code to perform the task, and information on a key mapped with the selected apparatus to perform a function in response to the control code, and the formed task list may then be registered. Accordingly, the user may only select one among the apparatuses found to perform the pairing operation, and thus user convenience is increased.

As described above, according to an exemplary embodiment of the present invention, when a control device provides a user with information regarding apparatuses able to be controlled in a home network, the user may only select one of the apparatuses corresponding to the provided information, so that the selected apparatus may be paired with the control device, and user convenience may be enhanced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A control device comprising:
a search unit which receives profiles from each of a plurality of apparatuses in a home network, and searches for in a searching, controllable apparatuses of the plurality of apparatuses able to be controlled in the home network;
a user interface unit which displays information regarding the controllable apparatuses found as a result of the searching; and
a control unit which pairs the control device with an apparatus selected from among the controllable apparatuses.

2. The control device as claimed in claim 1, wherein:
the user interface unit comprises a plurality of keys, and
the user interface unit maps each of the controllable apparatuses to one of the plurality of keys, illuminates the plurality of keys mapped to each of the controllable apparatuses, and displays the information regarding the controllable apparatuses.

3. The control device as claimed in claim 1, wherein the user interface unit comprises a touch screen which displays the information regarding the controllable apparatuses.

4. The control device as claimed in claim 1, wherein the user interface unit classifies the controllable apparatuses according to the received profiles, and displays the controllable apparatuses classified.

5. The control device as claimed in claim 4, wherein:
the user interface unit comprises a plurality of keys, and
the user interface unit maps each of the controllable apparatuses to one of the plurality of keys according to the type of apparatus classified, illuminates the plurality of keys mapped each of the controllable apparatuses, and displays the information regarding the controllable apparatuses.

6. The control device as claimed in claim 1, wherein the control unit transmits to the paired apparatus a control code to provide feedback to the paired apparatus.

7. The control device as claimed in claim 6, wherein:
the user interface unit comprises a plurality of keys,
the user interface unit maps each of the controllable apparatuses to one of the plurality of keys, and
the feedback comprises displaying the name of the key mapped with the selected apparatus, displaying a message notifying pairing completion, tuning to a channel corresponding to the name of the key mapping with the selected apparatus, outputting a predetermined sound, or turning on or off.

8. The control device as claimed in claim 1, wherein if a confirmation command is input or if a predetermined period of time has elapsed after a control code to provide feedback to the selected apparatus is transmitted to the selected apparatus, the control unit pairs the selected apparatus with the control device.

9. The control device as claimed in claim 1, wherein the control unit generates a task list comprising tasks able to be performed by the paired apparatus based on the received profiles.

10. A pairing method, comprising:
receiving profiles from each of a plurality of apparatuses in a home network, and searching for in a searching, controllable apparatuses of the plurality of apparatuses able to be controlled in the home network;
displaying information regarding the controllable apparatuses found as a result of the searching; and
pairing the control device with an apparatus selected from among the controllable apparatuses.

11. The pairing method as claimed in claim 10, wherein the displaying comprises mapping each of the controllable apparatuses to one of a plurality of keys, illuminating the plurality of keys mapped to each of the controllable apparatuses, and displaying the information regarding the controllable apparatuses.

12. The pairing method as claimed in claim 10, wherein the displaying comprises displaying on a touch screen the information regarding the controllable apparatuses.

13. The method as claimed in claim 10, wherein the displaying comprises classifying the controllable apparatuses according to the received profiles, and displaying the controllable apparatuses classified.

14. The pairing method as claimed in claim 13, wherein the displaying comprises mapping each of the controllable apparatuses to one of the plurality of keys according to the type of apparatus classified, illuminating the plurality of keys mapped to each of the controllable apparatuses, and displaying the information regarding the controllable apparatuses.

15. The pairing method as claimed in claim 10, wherein the pairing comprises transmitting to the paired apparatus a control code to provide feedback to the paired apparatus.

16. The pairing method as claimed in claim 15, wherein:
the displaying comprises mapping each of the controllable apparatuses to one of the plurality of keys, and
the feedback comprises one among operations of displaying the name of the key mapped with the selected apparatus, displaying a message notifying pairing completion, tuning to a channel corresponding to the name of the key mapping with the selected apparatus, outputting a predetermined sound, or turning on or off.

17. The pairing method as claimed in claim 10, wherein the pairing comprises if a confirmation command is input or if a predetermined period of time has elapsed after a control code to provide feedback to the selected apparatus is transmitted to the selected apparatus, pairing the selected apparatus with the control device.

18. The pairing method as claimed in claim 10, further comprising:
generating a task list containing tasks able to be performed by the paired apparatus based on the received profiles.

19. A control device for controlling a plurality of apparatuses which are connected to a network comprising:
a search unit which broadcasts a profile request signal and receives a plurality of profiles from responding apparatuses of the plurality of apparatuses, which respond to the profile request signal;
an user interface which displays information corresponding to the responding apparatuses and performs pairing with at least one of the responding apparatuses; and
a control unit which selects an apparatus and provides a control command to control the selected apparatus so that the selected apparatus is paired with the control device.

20. The network of claim 9, wherein the selected apparatus is controlled based on a task list comprising a plurality of tasks corresponding to a plurality of functions of the selected apparatus.
